(19) United States
(12) Patent Application Publication
(10) Pub. No.: US 2012/0081447 A1
(43) Pub. Date: Apr. 5, 2012

(54) TRANSPORT ADJUSTMENT METHOD, TRANSPORT ADJUSTMENT SYSTEM, AND TRANSPORT ADJUSTMENT PROGRAM

(75) Inventors: Tatsuya NAKANO, Shiojiri-shi (JP); Masahiko YOSHIDA, Shiojiri-shi (JP); Michiaki TOKUNAGA, Shiojiri-shi (JP); Takeshi YOSHIDA, Shiojiri-shi (JP)

(73) Assignee: SEIKO EPSON CORPORATION, Tokyo (JP)

(21) Appl. No.: 13/249,078

(22) Filed: Sep. 29, 2011

(30) Foreign Application Priority Data
Sep. 30, 2010 (JP) 2010-220805

(51) Int. Cl. B41J 29/38

(52) U.S. Cl. 347/16

(57) ABSTRACT

A transport adjustment method of adjusting transport of an image forming apparatus which includes a transport roller that transports a medium in a sub-scanning direction and a plurality of nozzles lining up in the sub-scanning direction and repeats the transport and main scanning of moving the plurality of nozzles in a main scanning direction, for each angle section formed by dividing one revolution of the transport roller into a plurality of angle sections, the method including: printing, by forming a ruled line by the main scanning every time the transport corresponding to the angle section is carried out, a test pattern in which a plurality of ruled lines is arranged; detecting an arrangement interval of the printed ruled lines; and adjusting the transport corresponding to the same angle section on the basis of the average value of a plurality of arrangement intervals corresponding to the same angle section.

### BACKGROUND

1. Technical Field

The present invention relates to a technique of adjusting transport of a medium by an image forming apparatus which repeats the transport of the medium in a sub-scanning direction and the discharge of ink involving nozzle movement in a main scanning direction.

2. Related Art

Hitherto, in an image forming apparatus such as an ink jet printer, a sheet-like medium such as paper or film has been transported by driving a transport roller. If the transport roller is eccentrically disposed, a rotary shaft of a motor which drives the transport roller is eccentrically disposed due to a mounting error on a frame, the circumferential length of the transport roller has variation, or the medium slips with respect to the transport roller, an error is generated in a transport distance of the medium which is derived from the angle of rotation of the transport roller. In general, in such an error, an AC component which is a transport error that periodically appears due to an eccentricity and a DC component which is a transport error caused by variation in the circumferential length of the transport roller or slippage of the medium are included.

In JP-A-2002-273956, JP-A-2008-302659, and JP-A-2008-260168, techniques of adjusting transport of a medium by individually detecting the AC component and the DC component of a transport error by reading a test pattern printed by an ink jet printer by using a scanner, and predicting a transport error which is generated in a practical mode on the basis of the transport error detected based on the test pattern are disclosed.

With respect to the AC component of the transport error due to an eccentricity, it is necessary to set a reference angle to the angle of rotation of a motor, finely divide 360° from the reference angle into a plurality of angle sections, and set a correction value for correcting a control amount for each angle section. On the other hand, the DC component of the transport error which is generated in the practical mode due to slippage between the medium and the transport roller cannot be accurately predicted if the slippage between the transport roller and the medium which is generated by transport in the practical mode is not reproduced.

However, according to methods disclosed in JP-A-2002-273956, JP-A-2008-302659, and JP-A-2008-260168, in order to simultaneously form a pattern for detecting the AC component of the transport error and a pattern for detecting the DC component of the transport error, the respective patterns are formed in the same transport mode. Therefore, according to the methods disclosed in JP-A-2002-273956, JP-A-2008-302659, and JP-A-2008-260168, there is a problem in that accuracy of detecting the AC component and the DC component of the transport error is low.

Further, in general, a printer has a plurality of printing modes such as a high-speed mode and a high-definition mode. However, slippage of the medium which is generated by intermittent transport in the respective modes is not constant. For this reason, a test pattern which allows slippage of the medium to be accurately predicted for each printing mode is needed.

### SUMMARY

An advantage of some aspects of the invention is that it increases transport accuracy of a medium in an image forming apparatus.

(1) According to a first aspect of the invention, there is provided a transport adjustment method of adjusting transport of an image forming apparatus which includes a transport roller that transports a medium in a sub-scanning direction and a plurality of nozzles lining up in the sub-scanning direction and repeats the transport and main scanning of moving the plurality of nozzles in a main scanning direction, for each angle section formed by dividing one revolution of the transport roller into a plurality of angle sections, the method including: printing, by forming a ruled line by the main scanning every time the transport corresponding to the angle section is carried out, a test pattern in which a plurality of ruled lines is arranged; detecting an arrangement interval of the printed ruled lines; and adjusting the transport corresponding to the same angle section on the basis of the average value of a plurality of arrangement intervals corresponding to the same angle section.

In the above aspect of the invention, with respect to an AC component of a transport error in a practical mode caused by an eccentricity of the transport roller, one revolution of the transport roller is divided into a plurality of angle sections and adjustment is performed for each angle section. If the test pattern related to the invention is printed, a ruled line is formed for each delimiter of the angle section. Therefore, if the test pattern related to the invention is used, the AC component of the transport error in the practical mode caused by an eccentricity of the transport roller can be predicted from the arrangement interval of the ruled lines. That is, according to the above aspect of the invention, by detecting the arrangement interval of a plurality of ruled lines formed on the medium, it is possible to accurately predict the AC component of the transport error in the practical mode except for a DC component caused by slippage between the transport roller and the medium. Here, also when forming a plurality of ruled lines on the medium, slippage between the transport roller and the medium can be generated. However, under the condition that the amount of slippage is sufficiently suppressed, certain slippage may be regarded as being generated even in intermittent transport corresponding to different angle sections. For example, it is acceptable if the average of a difference between the average of the arrangement intervals of the printed ruled lines and a reference interval (an arrangement interval as a control amount) of the ruled lines is regarded as the amount of slippage. However, slippage between the medium and the transport roller is irregularly generated. Therefore, transport corresponding to the same angle section is adjusted on the basis of the average value of a plurality of arrangement intervals corresponding to the same angle section. That is, according to the aspect of the invention, by accurately predicting the AC component of the transport error, thereby adjusting transport, it is possible to increase transport accuracy of the medium in the image forming apparatus.

(2) In the transport adjustment method according to the above aspect, the test pattern may be printed on rolled paper.

In a case where the test pattern is formed using cut paper as the medium, the test pattern can also be disposed on almost the entire area of the medium. Further, in a state where the upstream end of the cut paper and the nozzle face each other, only the transport roller disposed upstream of the nozzle comes into contact with the cut paper and the transport roller disposed downstream of the nozzle does not come into contact with the cut paper. The transport error which is generated in this state is a transport error of the transport roller disposed upstream of the nozzle. On the other hand, in a state where the downstream end of the cut paper and the nozzle face each other, only the transport roller disposed downstream of the nozzle comes into contact with the cut paper and the transport roller disposed upstream of the nozzle does not come into contact with the cut paper. The transport error which is generated in this state is a transport error of the transport roller disposed downstream of the nozzle. If the contact state of the transport roller with the medium during the period of printing the test pattern is different from that in the practical mode, the arrangement interval of the ruled lines cannot serve as the basis for accurately predicting the transport error in the practical mode. In contrast to this, in a case where the test pattern is formed using the rolled paper as the medium, since it is possible to leave long margins in the sub-scanning direction, it is possible to conform the condition of the transport roller which comes into contact with the medium when forming the test pattern on the medium to that in the practical mode.

(3) In the transport adjustment method according to the above aspect, the image forming apparatus may have a test mode for adjusting the transport by the test pattern and a practical mode of forming an image by transport adjusted on the basis of the test mode and acceleration of intermittent transport for printing the test pattern may be slower than that of transport in the practical mode.

Here, acceleration being slow means the absolute value of acceleration is relatively small. Further, intermittent transport means a series of motions of the transport roller from a motion of making the motion of the halted medium start up to motion of halting it again. Further, acceleration of the intermittent transport means a rate of change of angular velocity of the transport roller during the intermittent transport period.

In the intermittent transport, the larger the absolute value of the angular acceleration of the transport roller becomes, the larger a difference (this difference is called the amount of slippage) between the length of the surface of the transport roller passing a contact point between the transport roller and the medium per unit time and a progress distance of the medium per unit time becomes. If the test pattern which is formed according to the above aspect of the invention is used, the AC component of the transport error in the practical mode caused by the eccentricity of the transport roller can be predicted from an arrangement interval of a plurality of ruled lines which is formed on the medium by repeating the intermittent transport having slower acceleration than that in the practical mode. That is, according to the above aspect of the invention, by detecting the arrangement interval of a plurality of ruled lines formed on the medium, it is possible to accurately predict the AC component of the transport error in the practical mode except for the DC component caused by slippage between the transport roller and the medium.

In addition, the invention is also realized as a transport adjustment system, a transport adjustment program, and a recording medium of the transport adjustment program. Of course, the recording medium may be a magnetic recording medium or a magneto-optical recording medium or may also be any recording medium which may be developed hereafter.

### BRIEF DESCRIPTION OF THE DRAWINGS

The invention will be described with reference to the accompanying drawings, wherein like numbers reference like elements.

FIG. 1 is a schematic diagram illustrating a system configuration related to an embodiment of the invention.

FIG. 2 is a plan view related to the embodiment of the invention.

FIG. 3 is a line graph showing the relationship between a time and the angular velocity of a motor related to the embodiment of the invention.

FIG. 4 is a line graph showing the relationship between a time and the angular velocity of a motor related to the embodiment of the invention.

FIG. 5 is a flowchart related to the embodiment of the invention.

FIG. 6 is a schematic diagram illustrating scan data related to the embodiment of the invention.

FIG. 7 is a schematic diagram illustrating a calculation method related to the embodiment of the invention.

FIG. 8 is a flowchart related to the embodiment of the invention.

FIG. 9 is a plan view related to the embodiment of the invention.

### DESCRIPTION OF EXEMPLARY EMBODIMENTS

Hereinafter, embodiments of the invention will be described with reference to the accompanying drawings. Further, in each drawing, corresponding constituent elements are denoted by the same symbol and an overlapping description is omitted.

### 1. Overview

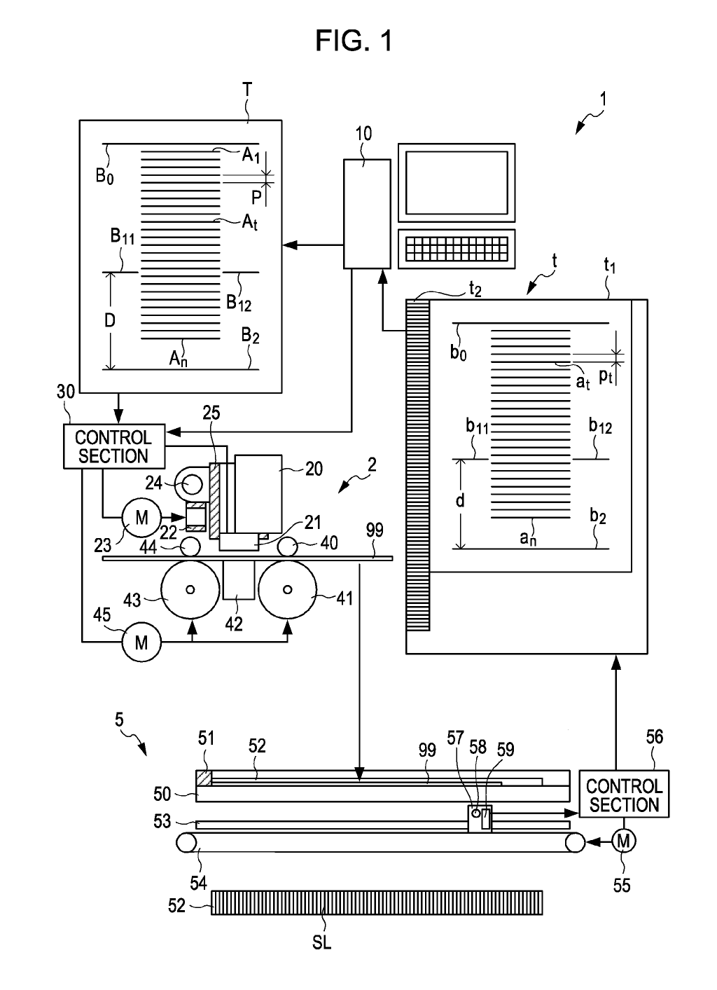

The configuration of a transport adjustment system 1 as one embodiment of the invention is shown in FIG. 1. The transport adjustment system 1 is constituted by a PC (Personal Computer) 10, a printer 2 connected to the PC 10, and a scanner 5. The transport adjustment system 1 is a system for adjusting an operation in which the printer 2 transports one of various sheets as a printing medium. That is, the PC 10 outputs test pattern data T to the printer 2, thereby making the printer 2 form a test pattern on rolled paper 99. The scanner 5 reads the test pattern formed on the rolled paper 99 and supplies scan data t representing the test pattern to the PC 10. The PC 10 detects distortion of a sub-scanning direction with respect to the test pattern data T of the test pattern formed on the rolled paper 99, on the basis of the scan data t, and adjusts transport in the printer 2 on the basis of the detected distortion.

### 2. Configuration of Printer

The printer 2 as an image forming apparatus is an ink jet printer which forms an image on the sheet by alternately repeating a transport operation of moving one of various sheets as the medium in the sub-scanning direction and a main scanning operation of discharging ink from nozzles while moving the nozzles in a main scanning direction.

The printer 2 includes transport rollers 41 and 43 and a motor 45 which drives the transport rollers 41 and 43. The motor 45 is a stepping motor which rotates by a certain angle (step angle) for each pulse. The angle of rotation of the motor 45 is controlled by the pulse number of a driving pulse and the rotational velocity of the motor 45 is controlled by the frequency of the driving pulse. Rotary encoders (not shown) are mounted on rotary shafts of the transport rollers 41 and 43. The angles of rotation and the rotational velocities of the transport rollers 41 and 43 are detected by the rotary encoders. Driven rollers 40 and 44 respectively come into contact with the transport rollers 41 and 43. The transport rollers 41 and 43 and the driven rollers 40 and 44 are respectively mounted so as to be able to rotate with respect to bearings (not shown). Since the sheet such as the rolled paper 99 is supplied between the transport rollers 41 and 43 and the driven rollers 40 and 44, the sheet is transported in the rotational directions of the transport rollers 41 and 43 by a frictional force which acts between the sheet and each of the transport rollers 41 and 43. Specifically, the rolled paper 99 is drawn between a platen 42 and a printing head 21 by a frictional force with the transport roller 43 on the downstream side, and the rolled paper 99 is extracted from between the platen 42 and the printing head 21 by a frictional force with the transport roller 41 on the upstream side. A static friction force which acts between the transport roller 41 on the upstream side and the rolled paper 99 exceeds a static friction force which acts between the transport roller 43 on the downstream side and the rolled paper 99 and also the circumferential velocity of the transport roller 41 on the upstream slightly exceeds the circumferential velocity of the transport roller 43 on the downstream. For this reason, in a state where the rolled paper 99 comes into contact with both the transport rollers 41 and 43, a transport distance of the rolled paper 99 is determined by the angle of rotation of the transport roller 41 on the upstream side.

Here, the printer 2 operates in a test mode for printing the test pattern and an practical mode for carrying out printing in a state where transport is adjusted on the basis of the test pattern. In the test mode, the sheet is transported by any one of first intermittent transport, in which a single transport distance is equivalent to 568 steps of the motor 45, and second intermittent transport, in which a single transport distance is equivalent to 1136 steps of the motor 45. In the practical mode, the sheet is transported by the second intermittent transport in which a single transport distance is equivalent to 1136 steps of the motor 45.

Further, the printer 2 includes the printing head 21, in which the nozzles are opened in the bottom surface, and a motor 23 for moving the printing head 21 in the main scanning direction. In the printing head 21, a discharge mechanism for discharging ink from the nozzle in a known method such as a piezoelectric method or a thermal method is provided. A carriage 25, on which the printing head 21 and an ink cartridge 20 are mounted, is mounted so as to be able to slide with respect to a guide rod 24. The guide rod 24 is fixed to a frame (not shown) in a position parallel to the rotary shafts of the transport rollers 41 and 43. An endless belt 22 which is driven by the motor 23 is fixed to the carriage 25. For this reason, by rotation of the motor 23, the carriage 25 which is towed by the endless belt 22 moves in a direction (the main scanning direction) perpendicular to a direction (the sub-scanning direction) in which the rolled paper 99 is transported.

The motors 45 and 23 and the printing head 21 are controlled by a control section 30 provided in the printer 2. The control section 30 includes a CPU, an EEPROM, a RAM, and an interface circuit. The control section 30 controls the motors 45 and 23 and the printing head 21 on the basis of printing data such as the test pattern data T which is supplied from the PC 10. In the EEPROM of the control section 30, various correction values for controlling the motors 45 and 23 and the printing head 21 on the basis of the printing data are stored. Transport of the rolled paper 99 is adjusted by setting an AC correction value and a DC correction value, which are correction values for controlling the motor 45.

The AC correction value is set for each angle section in which 360° from the reference angle of the motor 45 is divided at regular intervals. In this embodiment, the motor 45 is set to rotate 360° in 24992 steps and the width of each angle section is set to correspond to 568 steps, whereby the AC correction value is set for every 44 angle sections. The AC correction value has higher resolution than the step resolution of the motor 45. Specifically, the AC correction value has twice the resolution of the step resolution, and one step corresponds to a transport distance equivalent to 1/5760 inches, whereas the AC correction value corresponds to a transport distance equivalent to 1/11520 inches.

### 3. Configuration of Test Pattern

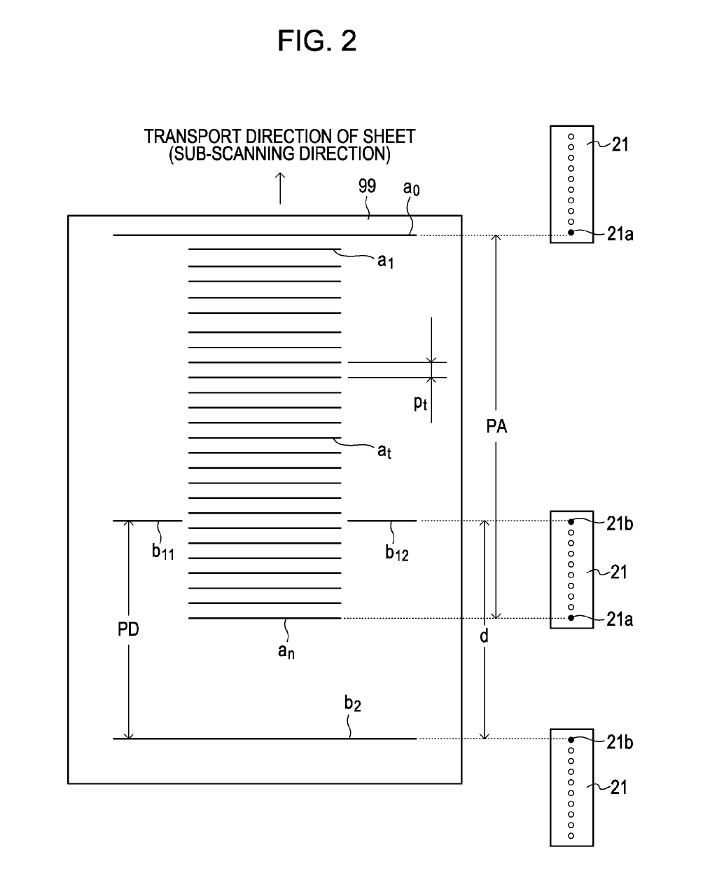

As shown in FIG. 2, the test pattern which is formed on the rolled paper 99 is formed on the basis of the test pattern data T which is supplied from the PC 10 to the printer 2. The test pattern has a first ruled line aₜ (t=0, 1, 2, . . . , or n) which constitutes a first pattern for detecting an AC component of a transport error, and second ruled lines b₁₁, b₁₂, and b₂, which constitute a second pattern for detecting a DC component of the transport error.

Each first ruled line aₜ constituting the first pattern has a line width of one dot and is formed at a position in the sub-scanning direction corresponding to a first ruled line component Aₜ of the test pattern data T by ink which is discharged from one specific nozzle. A nozzle (a first nozzle) 21a which discharges ink for forming the first ruled line aₜ is located at the most downstream side of the printing head 21. The first ruled line components Aₜ constitute a column of line segments parallel to the main scanning direction. Further, each first ruled line component Aₜ is arranged at the center in the main scanning direction in order to eliminate the influence of skew. Further, the first ruled line components Aₜ are arranged in the sub-scanning direction at intervals P and at regular intervals. The interval P corresponds to the width of the angle section and also corresponds to the transport distance equivalent to 568 steps of the motor 45. A first ruled line a₀ also constitutes a ruled line for inclination detection. The ruled line for inclination detection a₀ is longer in the main scanning direction than other first ruled lines. The number of intervals of the first ruled line components Aₜ is 88 equivalent to twice the number of sections. That is, an AC component detection pattern PA which is constituted by 89 first ruled lines aₜ has a length in the sub-scanning direction equivalent to two rounds of the transport roller 41 and has 88 intervals equal to twice the number of angle sections.

The second ruled lines b₁₁ and b₁₂ which constitute together the second pattern and the second ruled line b₂ which constitutes the second pattern respectively have a line width of one dot and respectively constitute a line segment parallel to the main scanning direction. The second ruled lines b₁₁, b₁₂, and b₂ are respectively formed at positions in the sub-scanning direction corresponding to second ruled line components B₁₁, B₁₂, and B₂ of the test pattern data T by ink which is discharged from one specific nozzle. A nozzle (a second nozzle) 21b which discharges ink for forming the second ruled lines b₁₁, b₁₂, and b₂ is a nozzle which is located at the most upstream side of the printing head. The second ruled line components B₁₁ and B₁₂ are disposed line-symmetrically with the central line in the main scanning direction as an axis of symmetry, in the vicinity of the central line in the main scanning direction, in order to eliminate the influence of skew. The positions in the sub-scanning direction of the second ruled line components B₁₁ and B₁₂ are the same. A distance D in the sub-scanning direction from the second ruled line components B₁₁ and B₁₂ to the second ruled line component B₂ corresponds to the length of one round of the transport roller 41. That is, a DC component detection pattern PD which is constituted by the second ruled lines b₁₁, b₁₂, and b₂ has a length in the sub-scanning direction equivalent to one round of the transport roller 41.

### 4. Printing of Test Pattern

Printing of the test pattern by the printer 2 is carried out in the test mode for adjusting transport of the rolled paper 99. When printing is carried out on the basis of the test pattern data T which is output from the PC 10, the ruled line for inclination detection a₀ is first formed on the rolled paper 99 on the basis of a first ruled line component A₀ of the test pattern data T by ink which is discharged from the nozzle 21a of the downstream end.

If the ruled line for inclination detection a₀ is formed on the rolled paper 99, after the motor 45 rotates by 568 steps for one angle section where an AC correction value AC₁ is set, a first ruled line a₁ corresponding to a first ruled line component A₁ is formed on the rolled paper 99 by ink which is discharged from the same nozzle 21a of the downstream end.

Then, if a first ruled line aₜ₋₁ corresponding to a first ruled line component Aₜ₋₁ is formed on the rolled paper 99 by ink which is discharged from one nozzle 21a of the downstream end, after the motor 45 rotates by 568 steps for one angle section where an AC correction value ACₜ is set, the first ruled line aₜ corresponding to the first ruled line component Aₜ is formed on the rolled paper 99 by ink which is discharged from the same nozzle 21a. By alternately repeating main scanning and intermittent transport in this manner, the AC component detection pattern PA composed of 89 first ruled lines aₜ and 88 gaps and having a length in the sub-scanning direction equivalent to two rounds of the transport roller 41 is formed on the rolled paper 99.

In the main scanning in which a first ruled line a₈₈ of the downstream end is formed on the rolled paper 99 by ink which is discharged from the nozzle 21a of the downstream end, the second ruled lines b₁₁ and b₁₂ corresponding to the second ruled line components B₁₁ and B₁₂ are formed on the rolled paper 99 by ink which is discharged from the nozzle 21b of the upstream end. That is, the first ruled line a₈₈ constituting the downstream end of the AC component detection pattern PA and the second ruled lines b₁₁ and b₁₂ constituting the upstream end of the DC component detection pattern PD are formed by the same main scanning.

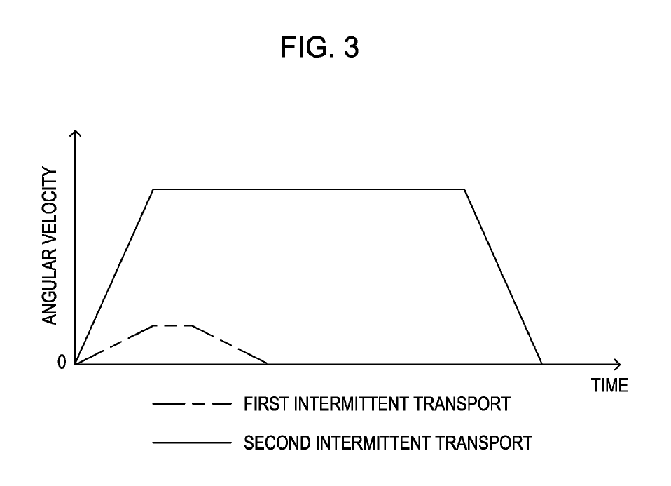

In the intermittent transport (the first intermittent transport) which is repeated until the first ruled line a₈₈ and the second ruled lines b₁₁ and b₁₂ are formed on the rolled paper 99, acceleration is set to be slower than that in the intermittent transport which is carried out in the practical mode with transport adjusted. Then, if the first ruled line a₈₈ and the second ruled lines b₁₁ and b₁₂ are formed on the rolled paper 99, the rolled paper 99 is transported by the second intermittent transport in which the same acceleration as that in the intermittent transport which is carried out in the practical mode is set. That is, as shown in FIG. 3, acceleration and deceleration in the second intermittent transport become faster than those in the first intermittent transport. Specifically, when the acceleration of an acceleration section in the first intermittent transport is set to be α₁, the acceleration of a deceleration section in the first intermittent transport is set to be β₁, the acceleration of an acceleration section in the second intermittent transport is set to be α₂, and the acceleration of a deceleration section in the second intermittent transport is set to be β₂, the following Expressions (1) and (2) are established.

|α₁|<|α₂| (1)

|β₁|<|β₂| (2)

Further, a distance in which the rolled paper 99 is transported by a single first intermittent transport is shorter than a distance in which the rolled paper 99 is transported by a single second intermittent transport.

After the first ruled line a₈₈ and the second ruled lines b₁₁ and b₁₂ are formed on the rolled paper 99, the motor 45 rotates by 24992 steps equivalent to one round of the transport roller 41 and the second ruled line b₂ corresponding to the second ruled line component B₂ is then formed on the rolled paper 99 by ink which is discharged from the nozzle 21b of the upstream end. Therefore, the length in the sub-scanning direction of the DC component detection pattern PD composed of the second ruled lines b₁₁, b₁₂, and b₂ corresponds to one round of the transport roller 41.

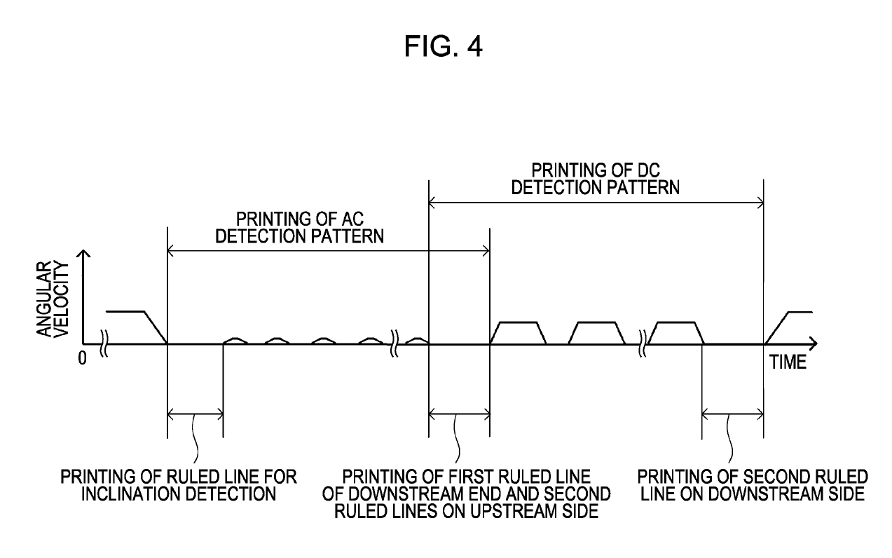

Transport from the second ruled lines b₁₁ and b₁₂ up to the second ruled line b₂ is carried out by alternately repeating the second intermittent transport and stop, as shown in FIG. 4. Specifically, in order to reliably cancel out logical seeking, a dot component (not shown) is included in the test pattern data T such that the second intermittent transport and ink discharge of several dots are repeated even between the second ruled lines b₁₁ and b₁₂. That is, by disposing a plurality of dot components, which is not included in the DC component detection pattern PD, at regular intervals in the sub-scanning direction, control is performed such that the second intermittent transport and stop are reliably repeated during formation of the DC component detection pattern PD in the same manner as printing in the practical mode.

As described above, in the test pattern which is printed on the rolled paper 99, the AC component detection pattern PA composed of the first ruled lines aₜ and the DC component detection pattern PD composed of the second ruled lines b₁₁, b₁₂, and b₂ partially overlap in the sub-scanning direction, as shown in FIG. 2. That is, a plurality of first ruled lines including the first ruled line a₈₈ of the downstream end of the AC component detection pattern PA is disposed between the second ruled lines b₁₁ and b₁₂ on the upstream side of the DC component detection pattern PD and the second ruled line b₂ on the downstream side of the DC component detection pattern PD. In order to acquire the AC correction values with respect to all the angle sections of the motor 45, as the length in the sub-scanning direction of the AC component detection pattern PA, a length equal to or more than the length of one round of the transport roller 41 is needed. Further, in order to acquire the DC correction value in which the AC component is not included, with respect to the length in the sub-scanning direction of the DC component detection pattern PD, a length equal to or more than the length of one round of the transport roller 41 is needed. By arrangement in which the AC component detection pattern PA and the DC component detection pattern PD overlap in the sub-scanning direction, the length in the sub-scanning direction of the entire test pattern which includes the AC component detection pattern PA and the DC component detection pattern PD can be shortened. Therefore, even in a case where the diameter of the transport roller 41 is large, it is possible to form the test pattern which includes the AC component detection pattern PA and the DC component detection pattern PD on a smaller area of the rolled paper 99. For example, even in a case where the length of one round of the transport roller 41 is 4.33 inches and exceeds twice the center-to-center distance of the nozzle 21b of the upstream end and the nozzle 21a of the downstream end, the length in the sub-scanning direction of the test pattern becomes 278.2 mm and becomes shorter than the long side of an A4-size. In this case, it is also possible to print the test pattern on A4-size cut paper.

However, in a case where upper and lower margins of the cut paper with respect to the test pattern become small, the test pattern has to be printed even in a state where the cut paper is transported by the transport roller 43 on the downstream side without contact of the cut paper with the transport roller 41 on the upstream side and even in a state where the cut paper is transported by the transport roller 41 on the upstream side without contact of the cut paper with the transport roller 43 on the downstream side. In this case, since a transport error different from that in the practical mode in which the cut paper is transported by both the transport rollers 41 and 43 appears in the printed result of the test pattern, the degree of precision of a transport error in the practical mode which is predicted on the basis of the printed result of the test pattern is slightly lowered.

Further, since in the first intermittent transport for forming the AC component detection pattern PA in the test mode, acceleration is slower than that in the intermittent transport in the practical mode, the amount of slippage between the transport roller 41 and the rolled paper 99 in the first intermittent transport becomes smaller than the amount of slippage in the practical mode. Therefore, it is possible to accurately predict the AC component of the transport error in the practical mode on the basis of the AC component detection pattern PA. Further, since a transport distance by the first intermittent transport for forming the AC component detection pattern PA in the test mode is set to be shorter than a transport distance by the intermittent transport in the practical mode, it is possible to increase correction resolution of the AC component corresponding to the number of angle sections of the motor 45. On the other hand, since the second intermittent transport for forming the DC component detection pattern PD in the test mode is set to have acceleration which is the same as that in the intermittent transport in the practical mode, the amount of slippage between the transport roller 41 and the rolled paper 99 in the second intermittent transport becomes equal to the amount of slippage in the practical mode. Therefore, it is possible to accurately predict the DC component of the transport error in the practical mode on the basis of the DC component detection pattern PD. Further, since in the second intermittent transport, the transport distance of the rolled paper 99 becomes longer than the transport distance of the rolled paper 99 by the first intermittent transport and the absolute value of the acceleration becomes larger than that in the first intermittent transport, it is possible to form the DC component detection pattern PD in a short period of time and as a result, it is possible to shorten a time required for printing of the entire test pattern.

### 5. Configuration of Scanner

The test pattern printed on the rolled paper 99 is optically read by the scanner 5. The scanner 5 includes a platen glass 50 for placing the rolled paper 99, and a manuscript guide 51 having an L-shaped end surface for positioning the rolled paper 99 on the platen glass 50. Further, the scanner 5 includes a light source 58 for illuminating a manuscript, a linear image sensor 59 for reading the illuminated manuscript, and a carriage 57 for transporting the linear image sensor 59 and the light source 58. The carriage 57 is mounted so as to be able to slide with respect to a guide rod 53. The guide rod 53 is fixed to a frame (not shown) in a position parallel to the platen glass 50. An endless belt 54 which is driven by a motor 55 is fixed to the carriage 57. The motor 55 is a stepping motor which is controlled by a pulse that is output from a control section 56 provided in the scanner 5. The control section 56 includes a CPU, an EEPROM, a RAM, and an interface circuit. The control section 56 controls the motor 55, the light source 58, and the linear image sensor 59 on the basis of a demand which is received from the PC 10, and also transmits the scan data which is output from the linear image sensor 59, to the PC 10.

The interval between the first ruled lines and the interval between the second ruled lines, which constitute the test pattern, are measured with a pixel constituting the test pattern data T read by the scanner 5 as a unit. The arrangement interval in the sub-scanning direction of the pixels constituting the test pattern data T is determined by the angle of rotation of the motor 55 which rotates while two adjacent arbitrary lines is read by the linear image sensor 59. Variation due to an error is present in a distance in which the carriage 57 moves while the two adjacent arbitrary lines are read by the linear image sensor 59. In order to cancel out the influence of the variation, a reference pattern which is read together with the test pattern is prepared.

The reference pattern is formed on a reference plate 52 which is attached to the platen glass 50. A plurality of slits SL constituting the reference pattern is formed in the reference plate 52. The slits SL are drawn at a pitch of 0.0353 mm by an ultrahigh precision laser. The reference plate 52 is attached to the platen glass 50 such that the end surface in a longitudinal direction comes into contact with the end surface of the manuscript guide 51 which extends in a direction (the sub-scanning direction) in which the carriage 57 moves. The slits SL of the reference plate 52 attached in this manner become parallel to the main scanning direction of the scanner 5.

### 6. Transport Adjustment Method

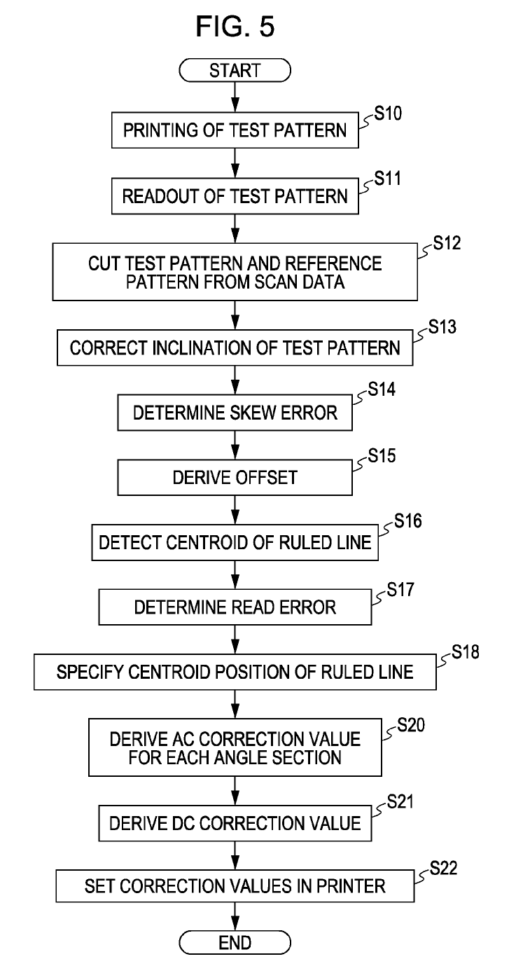

FIG. 5 is a flowchart showing the procedure of adjusting the transport of the above-described printer 2. Printing and readout of the test pattern, an analysis of the scan data, and setting of the correction value, which are described below, are controlled by a transport adjustment program which is executed in the PC 10.

First, the PC 10 outputs the test pattern data T, thereby making the printer 2 operating in the test mode print the test pattern (S10). The printing of the test pattern is as already described.

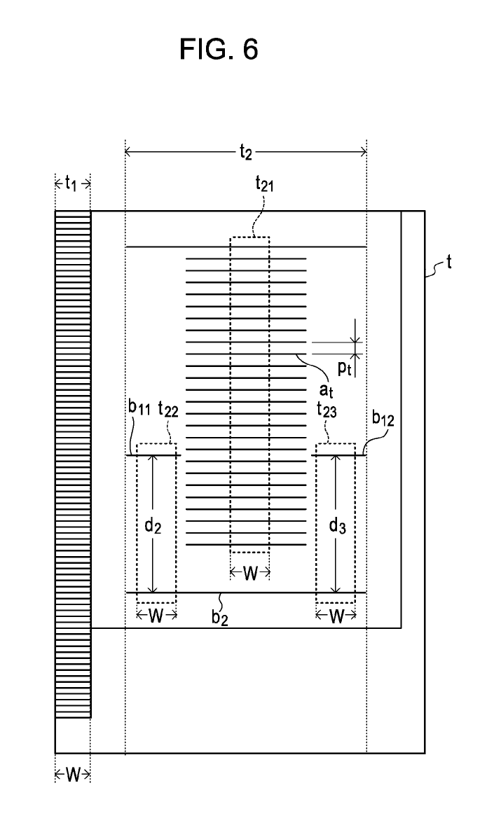

Next, an operator places the rolled paper 99 with the test pattern printed thereon on the platen glass 50 of the scanner 5 and makes the scanner 5 read the test pattern. As a result, the scan data t is input from the scanner 5 to the 00 (S11). The rolled paper 99 with the test pattern printed thereon is placed on the platen glass 50 in a state where two sides touch the reference plate 52 and the manuscript guide 51. If the test pattern is read by the scanner 5 in a state where the rolled paper 99 is placed on the platen glass 50 in this way, the scan data t shown in FIG. 6 is input to the PC 10.

Next, the PC 10 cuts an area t₂ corresponding to the test pattern and an area t₁ corresponding to the reference pattern from the scan data t (S12).

Next, the PC 10 corrects an inclination of the area t₂ corresponding to the test pattern (S13). Specifically, the PC 10 detects an angle θ that the ruled line for inclination detection a₀ makes with the horizontal direction (the main scanning direction of the scanner) and rotates the area t₂ by the angle θ.

Next, the PC 10 detects whether or not skew generated during printing of the test pattern is within an acceptable range, and if it is out of the acceptable range, the PC 10 gives notice of an error and then ceases subsequent processing (S14). Specifically, whether or not an inclination of the second ruled line b₂ with respect to the ruled line for inclination detection a₀ is within an acceptable range is detected, and if it is out of the acceptable range, an error is notified and subsequent processing is then ceased.

If the area t₂ is rotated in S13, the centroid of each ruled line of the test pattern is moved in the sub-scanning direction when viewing from a coordinate system of the test pattern data T which did not rotate. However, the position in the sub-scanning direction of each ruled line of the test pattern printed on the rolled paper 99 is specified with the position in the sub-scanning direction of the reference pattern read in the area t₂ which did not move in the sub-scanning direction when viewing from a coordinate system of the test pattern data T as a standard. For this reason, correction of cancelling out movement of the centroid of each ruled line in the sub-scanning direction viewed from a coordinate system of the area t₁ which did not rotate, due to rotation of the area t₂, is needed. Therefore, the PC 10 derives the movement amount (offset) of the centroid of each ruled line in the sub-scanning direction viewed from a coordinate system of the area t₁, which did not rotate, due to rotation of the area t₂ (S15).

Next, the centroid of each ruled line of the test pattern which is shown in the area t₂ and the centroid of each ruled line of the reference pattern which is shown in the area t₁ are detected (S16). Specifically, with respect to each of an area t₂₁ of the area t₂, which includes a portion of each first ruled line and does not include margins of both sides of the first ruled line, areas t₂₂ and t₂₃ of the area t₂, which respectively include a portion of each second ruled line and do not include margins of both sides of the second ruled lines, and the area t₁, a density average for each line is derived. Here, the density average is a value obtained by dividing the total value of density (luminance) for each line of the areas t₁, t₂₁, t₂₂, and t₂₃ by a width W (a length in the main scanning direction) of each area. Then, the position (coordinate value) in the sub-scanning direction of the centroid of each line of the reference pattern and the test pattern is detected with the position in the sub-scanning direction of the line, in which a density average takes the maximum value in a larger range than a threshold value, as a standard.

Next, the PC 10 determines whether or not the distance (an arrangement interval) between the centroids of the ruled lines is within a reference range, and in a case where it exceeds the reference range, the PC 10 gives notice of an error and then ceases subsequent processing (S17). For example, in a case where the density of the read ruled line becomes abnormally low due to a disturbance such as vibration or the ruled line is doubly read, it becomes an error. The reference range is set on the basis of the maximum transport error of the printer 2 which is assumed and the maximum read error of the scanner 5.

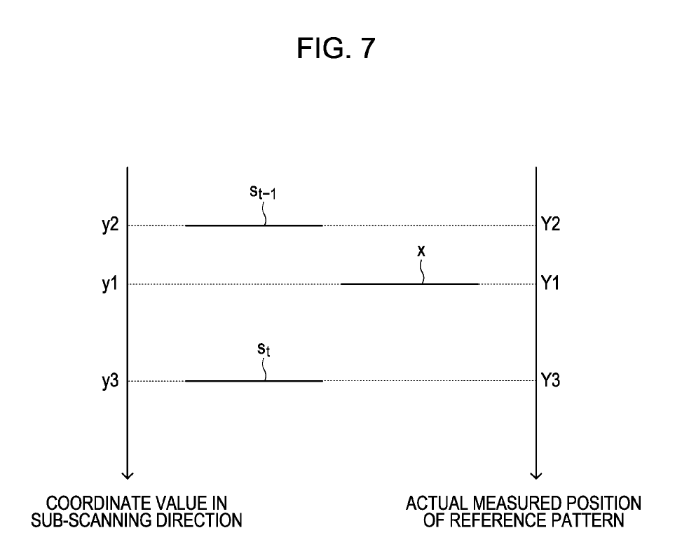

Next, the PC 10 applies the offset derived in S15 with the coordinate value in the sub-scanning direction of the centroid of each ruled line of the reference pattern as a standard, thereby specifying the position (coordinate value) in the sub-scanning direction of the centroid of each ruled line of the test pattern (S18). Specifically, it is as follows. An arbitrary ruled line x constituting the test pattern is read between two adjacent ruled lines sᵤ and sᵤ₊₁ of the reference pattern. Here, as shown in FIG. 7, if the coordinate values in the sub-scanning direction of ruled lines x, sₜ₋₁, and sₜ, in which the centroids are detected, are respectively set to be y₁, y₂, and y₃ (y₃>y₁>y₂) and the positions in the sub-scanning direction of the ruled lines sᵤ and sᵤ₊₁ which are previously measured are set to be Y₂ and Y₃ (Y₃>Y₂), a position Y₁ of the arbitrary ruled line x constituting the test pattern is specified by the following Expression (3).

Y₁=(Y₃−Y₂){(y₁−y₂)/(y₃−y₂)}+Y2 (3)

That is, the position of the ruled line constituting the test pattern is specified with a position where the slit SL of the reference pattern, in which an accurate position in the sub-scanning direction is previously specified in the surface of the platen glass 50, is read in the scan data t, as a standard.

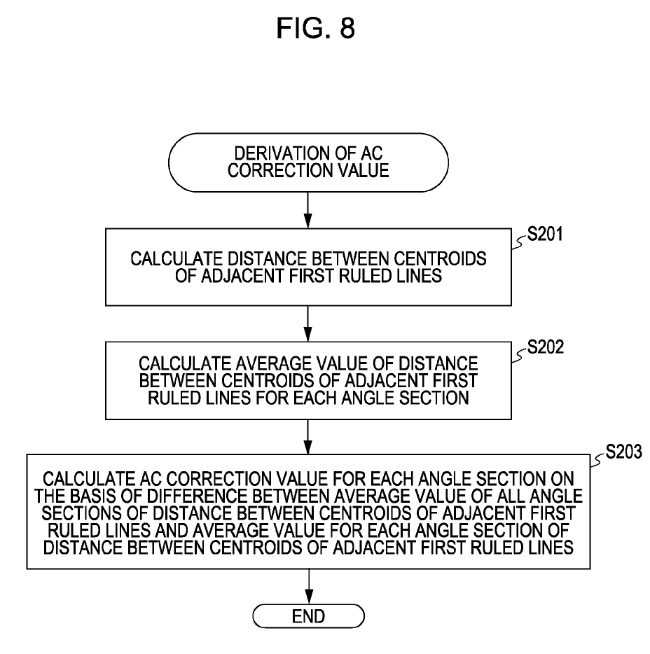

Next, the PC 10 derives the AC correction value for each angle section on the basis of the position in the sub-scanning direction of the specified first ruled line (S20). FIG. 8 is a flowchart showing the procedure of deriving the AC correction value.

First, a distance between the centroids of adjacent first ruled lines is calculated (S201). Specifically, if it is assumed that the position in the sub-scanning direction of the first ruled line aₜ is specified to be Yₜ, a distance pₜ between the centroids of the first ruled line aₜ and the first ruled line aₜ₋₁ is calculated by the following Expression (4). In addition, in the following Expression (4), t=1, 2, . . . , or 88.

pₜ=Yₜ−Yₜ₋₁ (4)

Here, pₜ is the sum of a theoretical value of a transport distance of a single first intermittent transport, the DC component of a transport error generated in the first intermittent transport, and the AC component of a transport error generated in the first intermittent transport.

Next, an average value Ave(t) of two distances between the centroids corresponding to the same angle section is calculated by the following Expression (5) (S202). “44” is the number of angle sections. In addition, in the following Expression (5), t=1, 2, . . . , or 44.

Ave(t)=pₜ+pₜ₊₄₄ (5)

If Ave(t) is sought, a transport error due to slippage between the rolled paper 99 and the transport roller 41, which may irregularly occur for each angle section, is averaged.

Next, a value that is obtained by subtracting a theoretical value of the distance between the centroids of the first ruled lines from the average value Ave(t) of two distances between the centroids corresponding to the same angle section is calculated for each angle section as a first intermediate value S₁(t).

Next, an AC correction value Adj(t) is calculated for each angle section on the basis of a difference between an average value p_{A} of the distance pₜ between the centroids of adjacent first ruled lines and the first intermediate value S₁(t) (S203).

Specifically, first, the average value p_{A} of the distance pₜ between the centroids of adjacent first ruled lines is calculated by the following Expression (6).

p_{A}=(p₁+p₂+ . . . +p₈₈)/88 (6)

p_{A} is equivalent to an average value of the DC components of transport errors generated in the first intermittent transports of each two times with respect to all the angle sections. Since a transport distance by the first intermittent transport of each angle section is short, p_{A} may be regarded as being the DC component itself of the transport error generated in the first intermittent transport of each angle section.

Therefore, a value in which the DC component of the transport error in the first intermittent transport is removed by subtracting p_{A} from the first intermediate value S₁(t) and a numerical unit is converted from a pixel into ½ step of the motor 45 is calculated as an AC correction value AC(t) of each angle section. When converting a numerical unit from a pixel into ½ step, the AC correction value AC(t) is rounded off for each angle section and also a fraction rounded down or rounded up is added to an AC correction value AC′ (t+1) before subsequent rounding-off. Then, an AC correction value AC(44) of the last angle section is set to be a value in which the plus and the minus of the sum from an AC correction value AC(1) to an AC correction value AC(43) are reversed such that the sum of the AC correction values of all the angle sections becomes 0.

If the AC correction value AC(t) is derived with respect to all the angle sections in this way, next, the PC 10 derives a DC correction value DC (S21). Specifically, first, the distances d₂ and d₃ between the centroids of the second ruled lines are calculated with respect to each of the areas t₂₂ and t₂₃ shown in FIG. 6 and the average value of the calculated distances d₂ and d₃ between the centroids is calculated as a second intermediate value S₂. Next, a value which is obtained by subtracting a theoretical value of the distance between the centroids of the second ruled lines b₁₁ and b₁₂ and the second ruled line b₂ from the second intermediate value S₂ is calculated and a value in which a numerical value is converted from a pixel into one step of the motor 45 and rounded off is calculated as the DC correction value DC.

Next, the PC 10 sets the AC correction value AC(t) and the DC correction value DC in the printer 2. The AC correction value AC(t) and the DC correction value DC are written in the EEPROM of the control section 30 of the printer 2 in formats shown in the following Table 1. In addition, in Table 1, a correction value resolution conversion factor is a value which is obtained by dividing resolution (11520 dpi) of the AC correction value equivalent to ½ step of the motor 45 by transport resolution (5760 dpi) corresponding to one step of the motor 45.

TABLE 1

| | | | Bite | Ex- |
|---|---|---|---|---|
| Address | Item | Unit | number | ample |
| 1 | DC correction value: DC | 1/5760 inches | 2 | 3 |
| 3 | Step number/one revolution | 1/5760 inches | 2 | 24992 |
| 5 | Number of angle sections | | 2 | 44 |
| 7 | Correction value resolution | | 2 | 2 |
| | conversion factor μ | | | |
| 9 | AC correction value: AC(1) | 1/11520 inches | 2 | −1 |
| 11 | AC correction value: AC(2) | 1/11520 inches | 2 | 0 |
| . | . | . | . | . |
| . | . | . | . | . |
| . | . | . | . | . |
| 95 | AC correction value: AC(44) | 1/11520 inches | 2 | 1 |

### 7. Transport Adjustment

If the AC correction value AC(t) and the DC correction value DC are set in the printer 2, transport in the printer 2 is adjusted by doing as follows.

The AC correction value AC(t) represents a value which increases or decreases a pulse number that is applied to the motor 45 per single intermittent transport in the transport mode in which a transport distance for single intermittent transport is 568/11520 inches. Further, the DC correction value DC represents a value which increases or decreases a pulse number that is applied to the motor 45 per revolution of the transport roller 41. Therefore, the printer 2 sets a pulse number P which is applied to the motor 45 with respect to single transport, depending on the distance of the single transport in the practical mode. Further, depending on the angle section of the motor 45 to which the single transport corresponds, the pulse number P which is applied to the motor 45 with respect to the single transport is set.

In a case where single transport that is a target transport distance F (step) corresponds only to an angle section t of the motor 45, the pulse number P which is applied to the motor 45 with respect to the single transport is calculated by the following Expression (7).

P=AC(t)×(1/μ)×F/568+DC×(F/24992) (7)

In a case where the single transport that is the target transport distance F (step) corresponds to angle sections t−1 and t of the motor 45, the angle section t−1 of the motor 45 corresponds to a target transport distance f (step), and the angle section t of the motor 45 corresponds to a remaining target transport distance F−f (step), the pulse number P which is applied to the motor 45 with respect to the single transport is calculated by the following Expression (8).

P=AC(t−1)×(1/μ)×f/568+AC(t)×(1/μ)×(F−f)/568+AC(t)+DC×(F/24992) (8)

In a case where the single transport that is the target transport distance F (step) corresponds to angle sections t₁ and t₂ (t₂−t₁>1) of the motor 45, the angle sections t₁ corresponds to a target transport distance f₁ (step), and the angle sections t₂ corresponds to a target transport distance f₂ (step), the pulse number P which is applied to the motor 45 with respect to the single transport is calculated by the following Expression (9).

P=AC(t₁)×(1/μ)×f₁/568+AC(t₁+1)+AC(t₁+2) . . . +AC(t₂)×(1/μ)×f₂/568+DC×(F/24992) (9)

In the transport adjustment method described above, transport corresponding to the same angle section (t) is adjusted on the basis of the average value Ave(t) of a plurality of arrangement intervals corresponding to the angle section (t). For this reason, the transport error due to slippage between the rolled paper 99 and the transport roller 41, which may irregularly generated for each angle section, is averaged. Further, the AC correction value is set such that the sum of a plurality of AC correction values corresponding to the angle section for one revolution becomes zero. Therefore, since it is possible to adjust transport by accurately predicting the AC component of the transport error, it is possible to increase transport accuracy of the sheet in the printer 2.

### 8. Other Embodiments

Further, the technical scope of the invention is not limited to the above-described embodiment and, of course, various changes can be applied thereto within the scope that does not depart from the gist of the invention.

For example, it is also possible to constitute the test pattern without overlap of the AC detection pattern PA and the DC detection pattern PD in the sub-scanning direction. In this case, the first ruled lines constituting the AC detection pattern PA and the second ruled lines constituting the DC detection pattern PD may be formed by ink which is discharged from the same nozzle. Further, in this case, the first ruled line and the second ruled line are not formed in the same main scanning.

Further, using the nozzle on the most downstream side as the first nozzle corresponding to the pattern which is formed at the upstream side and the nozzle on the most upstream side as the second nozzle corresponding to the pattern which is formed at the downstream side is for maximally shortening the length in the sub-scanning direction of the test pattern. However, if the first nozzle is a nozzle which is located further at the downstream side than the second nozzle, it is possible to shorten the length in the sub-scanning direction of the test pattern by the distance between the first nozzle and the second nozzle.

Further, since due to the characteristics of a nozzle, depending on a nozzle, there is also a case where the density of a dot is not stable, it is also acceptable to select a nozzle in which the density of a dot is stable and form the AC detection pattern PA and the DC detection pattern PD by ink which is discharged from the selected nozzle.

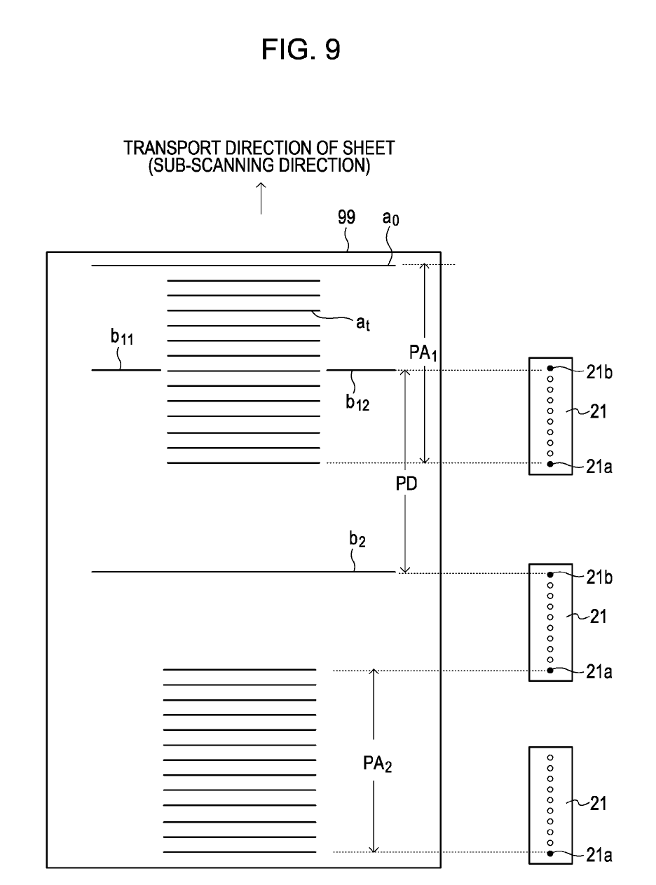

Further, as shown in FIG. 9, it is also possible to constitute the test pattern by disposing two AC detection patterns PA₁ and PA₂, which are respectively composed of the same number of first ruled lines aₜ, away from each other in the sub-scanning direction, and disposing the DC detection patterns PD so as to overlap a portion of the AC detection patterns PA₁ on the upstream side or the downstream side. In this case, the main scanning in which the first ruled line and the second ruled line are formed in the same main scanning is carried out twice.

Further, it is acceptable if the length in the sub-scanning direction of the AC detection pattern corresponds to one round of the transport roller 41. For example, the total length in the sub-scanning direction of the two AC detection patterns PA₁ and PA₂ shown in FIG. 9 may be set to correspond to one round of the transport roller 41. Further, it is also acceptable to divide the DC detection pattern into a plurality of DC detection patterns and set the total length in the sub-scanning direction of a plurality of divided DC detection patterns to correspond to one round of the transport roller 41.

Further, the test pattern according to the invention may also be used in adjustment of transport in an image forming apparatus having plural types of practical modes in which a medium is transported by the intermittent transports different from each other. For example, it is possible to use the first ruled line in order to detect a transport error in a high-definition printing mode and use the second ruled line in order to detect a transport error in a high-speed printing mode. In this case, the AC component and the DC component of the transport error are not separated. In such a case, both the length in the sub-scanning direction of the pattern composed of the first ruled lines for detecting the transport error in the high-definition printing mode in which the acceleration of transport is slow and the length in the sub-scanning direction of the pattern composed of the second ruled lines for detecting the transport error in the high-speed printing mode in which the acceleration of transport is fast may be shorter than the length of one round of the transport roller. This is because if the transport errors in the respective practical modes are predicted without separation of the AC component, a prediction can be performed if the length in the sub-scanning direction of the pattern is not equal to or more than one revolution of the roller.

Further, the first pattern constituting the AC detection pattern may be a pattern other than a line segment and the second pattern constituting the DC detection pattern may also be a pattern other than a line segment. For example, the AC detection pattern may also be constituted by arranging patterns having different densities in the sub-scanning direction.

Further, the arrangement interval of each pattern is not limited to the distance between the centroids of the pattern and may also be set to be the length of a void between two adjacent patterns or the distance between ends of the two adjacent patterns.

What is claimed is:

1. A transport adjustment method of adjusting transport of an image forming apparatus which includes a transport roller that transports a medium in a sub-scanning direction and a plurality of nozzles lining up in the sub-scanning direction and repeats the transport and main scanning of moving the plurality of nozzles in a main scanning direction, for each angle section formed by dividing one revolution of the transport roller into a plurality of angle sections, the method comprising:
printing, by forming a ruled line by the main scanning every time the transport corresponding to the angle section is carried out, a test pattern in which a plurality of ruled lines is arranged;
detecting an arrangement interval of the printed ruled lines; and
adjusting the transport corresponding to the same angle section on the basis of the average value of a plurality of arrangement intervals corresponding to the same angle section.

2. The transport adjustment method according to claim 1, wherein the test pattern is printed on rolled paper.

3. The transport adjustment method according to claim 1, wherein the image forming apparatus has a test mode for adjusting the transport by the test pattern and a practical mode of forming an image by transport adjusted on the basis of the test mode, and
acceleration of intermittent transport for printing the test pattern is slower than that of transport in the practical mode.

4. A transport adjustment system for adjusting transport of an image forming apparatus which includes a transport roller that transports a medium in a sub-scanning direction and a plurality of nozzles lining up in the sub-scanning direction and repeats the transport and main scanning of moving the plurality of nozzles in a main scanning direction, the system comprising:
a section that makes the image forming apparatus print, by forming a ruled line by the main scanning every time the transport corresponding to the angle section is carried out, a test pattern in which a plurality of ruled lines is arranged;
a section that detects an arrangement interval of the printed ruled lines; and
a section that adjusts the transport corresponding to the same angle section on the basis of the average value of a plurality of arrangement intervals corresponding to the same angle section.

5. A transport adjustment program for adjusting transport of an image forming apparatus which includes a transport roller that transports a medium in a sub-scanning direction and a plurality of nozzles lining up in the sub-scanning direction and repeats the transport and main scanning of moving the plurality of nozzles in a main scanning direction,
the program making a computer realize:
a function of printing, by forming a ruled line by the main scanning every time the transport corresponding to the angle section is carried out, by the image forming apparatus, a test pattern in which a plurality of ruled lines is arranged;
a function of detecting an arrangement interval of the printed ruled lines; and
a function of adjusting the transport corresponding to the same angle section on the basis of the average value of a plurality of arrangement intervals corresponding to the same angle section.
